(19) United States
(12) Patent Application Publication
(10) Pub. No.: US 2025/0013430 A1
(43) Pub. Date: Jan. 9, 2025

(54) RECONFIGURABLE ARCHITECTURE FOR IMPROVEMENT AND OPTIMIZATION OF ADVANCED ENCRYPTION STANDARD

(71) Applicant: The Board of Regents for the Oklahoma Agricultural and Mechanical Colleges, Stillwater, OK (US)

(72) Inventors: Ryan L. Swann, Meeker, OK (US); James E. Stine, JR., Stillwater, OK (US)

(21) Appl. No.: 18/897,174

(22) Filed: Sep. 26, 2024

Related U.S. Application Data
(63) Continuation of application No. PCT/US23/64442, filed on Mar. 15, 2023.
(60) Provisional application No. 63/324,966, filed on Mar. 29, 2022.

(51) Int. Cl. G06F 5/01; G06F 9/448; G06F 21/60

(52) U.S. Cl. CPC G06F 5/01; G06F 9/4498; G06F 21/602

(57) ABSTRACT

An improved implementation of an Advanced Encryption Standard is described, which in some aspects includes: a non-transitory computer-readable medium storing a first lookup table, a second lookup table, a plaintext, and a round key; a ShiftRows subassembly for shifting bytes of the plaintext; four combined SubBytes and MixColumns modules, including: a first data conversion engine for converting a first portion of the plaintext into a first result using the first lookup table; a second data conversion engine for converting a second portion of the plaintext into a second result using the second lookup table; and an even parity checker operating on the first result, the second result, and a third portion of the plaintext to produce a result array row; and an AddRoundKey subassembly operating on the round key and a result array formed by the result array rows from the four combined SubBytes and MixColumns modules.

### REFERENCE TO RELATED APPLICATIONS

The present patent application is a continuation from the international application designated as PCT serial no. PCT/US23/64442 filed on Mar. 15, 2023, which claims priority to the provisional patent application identified by U.S. Ser. No. 63/324,966, filed on Mar. 29, 2022, the entire contents of both of which are hereby incorporated herein by reference.

### STATEMENT REGARDING FEDERALLY SPONSORED RESEARCH

Not Applicable.

### BACKGROUND ART

As computer processors have increased in speed, so too have the requirements for fast and efficient cryptographic primitives (i.e., well-established, low-level cryptographic algorithms that are conventionally used to build cryptographic protocols for computer security systems) to enable designers and programmers to utilize secure design techniques without limiting the speed of other components. Moreover, as speeds continue to increase in networking, computing, and processing applications, it is increasingly important that computer security components are improved so that secure computing can keep pace with such applications.

One cryptographic primitive with wide-reaching applicability in modern technology is the Rijndael symmetric block cipher, a variant of which being more commonly known as the Advanced Encryption Standard (or “AES”). AES specifies a cryptographic algorithm ratified as a standard by the U.S. National Institute of Standards and Technology to protect electronic data. The AES algorithm is a symmetric block cipher that can encrypt (or “encipher”) and decrypt (or “decipher”) information. Encryption converts data into an unintelligible form (called “ciphertext”) such that decrypting the ciphertext converts the data back into its original form (called “plaintext”).

The AES algorithm uses a secret, cryptographic key (called a “cipher key”). The AES algorithm uses a single cipher key for both cipher (or “encipher”) and inverse cipher (or “decipher”) routines. This allows a system to securely transfer the cipher key to another system over a public channel (e.g., a Diffie-Hellman key exchange), where the cipher key can be used to decrypt a file that was encrypted on the original system at a rapid pace while also ensuring that the data cannot be intercepted by third parties in transit. Symmetric ciphers are therefore particularly useful for secure transfer of large amounts of data without the overhead of a symmetric key system (e.g., Elliptic Curve Cryptography).

There is a need in the art for new and improved implementations of the AES algorithm that enhance the operation of the computer in encrypting the data. It is to such an improved implementation of the AES algorithm that the present disclosure is directed.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Reference numerals in the figures may represent and refer to the same or similar element or function. In the drawings:

FIG. 1 is a process flow diagram of a prior art implementation of AES;

FIG. 2 is a substitution box used in a SubBytes transformation of the prior art implementation of AES shown in FIG. 1;

FIG. 3 is an illustration of a ShiftRows transformation of the prior art implementation of AES shown in FIG. 1;

FIG. 4A is a Galois Multiplication ×3 lookup table used in a MixColumns transformation of the prior art implementation of AES shown in FIG. 1;

FIG. 4B is a Galois Multiplication ×2 lookup table used in the MixColumns transformation of the prior art implementation of AES shown in FIG. 1;

FIG. 5 is a digital logic diagram of an even parity checker used in the MixColumns transformation of the prior art implementation of AES shown in FIG. 1;

FIG. 6 is a digital logic diagram of the MixColumns transformation of the prior art implementation of AES shown in FIG. 1;

FIG. 7 is an illustration of an AddRoundKey transformation of the prior art implementation of AES shown in FIG. 1;

FIG. 8A is a process flow diagram of an implementation of a cryptographic primitive conforming to the requirements of AES having an encipher core constructed in accordance with the present disclosure that enhances the operation of the cryptographic primitive as compared to the prior art implementation of AES shown in FIG. 1;

FIG. 8B is a block diagram of a computer system implementing the cryptographic primitive shown in FIG. 8A;

FIG. 9A is a combined SubBytes and Galois Multiplication ×3 lookup table used in a combined SubBytes and MixColumns transformation of the encipher core shown in FIG. 8B;

FIG. 9B is a combined SubBytes and Galois Multiplication ×2 lookup table used in the combined SubBytes and MixColumns transformation of the encipher core shown in FIG. 8B;

FIG. 10 is a digital logic diagram of the combined SubBytes and MixColumns transformation of the encipher core shown in FIG. 8B;

FIG. 11 is an illustration of an AddRoundKey transformation of the encipher core shown in FIG. 8B; and

FIG. 12 is a process flow diagram of an encipher method performed by the encipher core shown in FIG. 8B.

### DETAILED DESCRIPTION

As utilized in accordance with the present disclosure, the following terms, unless otherwise indicated, shall be understood to have the following meanings:

The use of the term “a” or “an” when used in conjunction with the term “comprising” in the claims and/or the specification may mean “one,” but it is also consistent with the meaning of “one or more,” “at least one,” and “one or more than one.” As such, the terms “a,” “an,” and “the” include plural referents unless the context clearly indicates otherwise. Thus, for example, reference to “a compound” may refer to one or more compounds, two or more compounds, three or more compounds, four or more compounds, or greater numbers of compounds. The term “plurality” refers to “two or more.”

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

The use of the term “or” in the claims is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used herein, any reference to “one embodiment,” “an embodiment,” “some embodiments,” “one example,” “for example,” or “an example” means that a particular element, feature, structure, or characteristic described in connection with the embodiment is included in at least one embodiment. The appearance of the phrase “in some embodiments” or “one example” in various places in the specification is not necessarily all referring to the same embodiment, for example. Further, all references to one or more embodiments or examples are to be construed as non-limiting to the claims.

Throughout this application, the term “about” is used to indicate that a value includes the inherent variation of error for a composition/apparatus/device, the method being employed to determine the value, or the variation that exists among the study subjects. For example, but not by way of limitation, when the term “about” is utilized, the designated value may vary by plus or minus twenty percent, or fifteen percent, or twelve percent, or eleven percent, or ten percent, or nine percent, or eight percent, or seven percent, or six percent, or five percent, or four percent, or three percent, or two percent, or one percent from the specified value, as such variations are appropriate to perform the disclosed methods and as understood by persons having ordinary skill in the art.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. For example, the term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

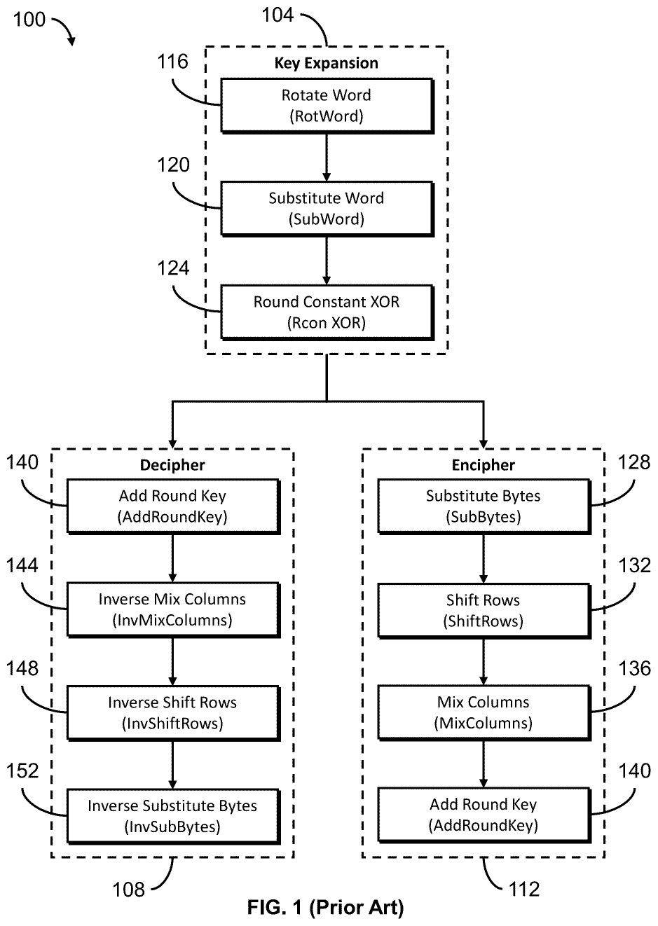

Turning now to the illustrative drawings, and in particular FIG. 1, shown therein is an exemplary prior art implementation of AES 100. The prior art implementation of AES 100 includes a key expansion routine 104, a decipher routine 108, and an encipher routine 112.

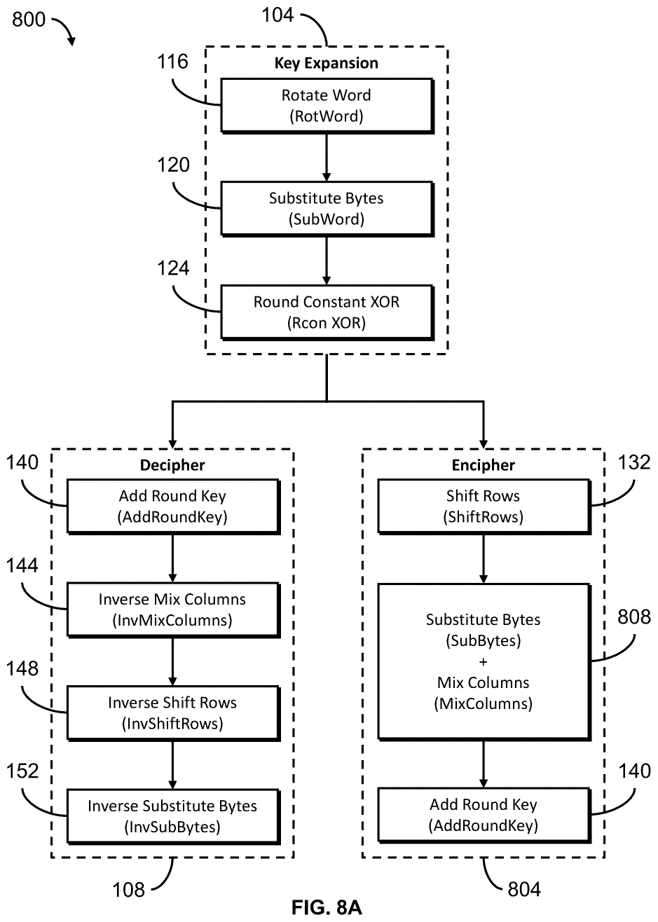

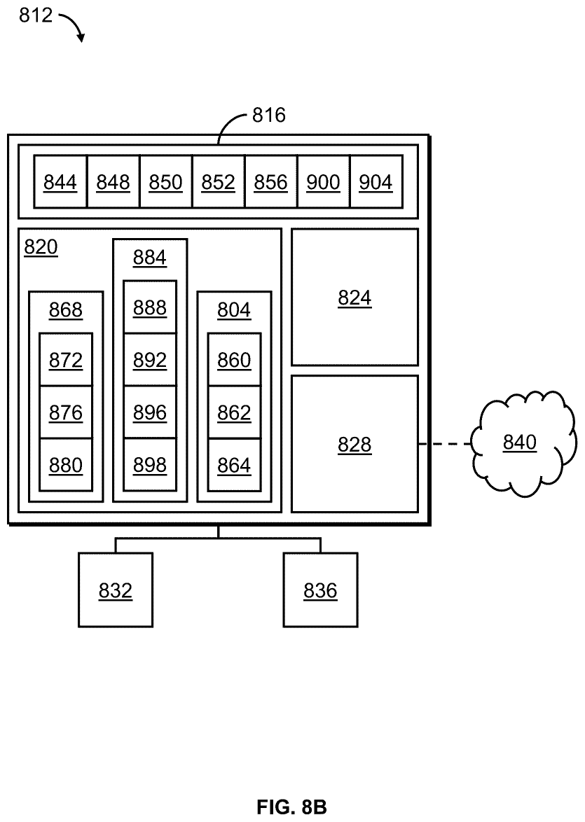

Each of the transformations performed by the AES algorithm are repeated a number of times, each of the repetitions being referred to as a round. The AES algorithm is capable of encrypting and decrypting data in blocks having a length of 128 bits (or 16 bytes) using a cipher key 850 (shown in FIG. 8B) having a length of Nk, where Nk is equal to the number of 32-bit words comprising the cipher key 850, which for the AES algorithm may be 4, 6, or 8 words (or 128, 192, or 256 bytes).

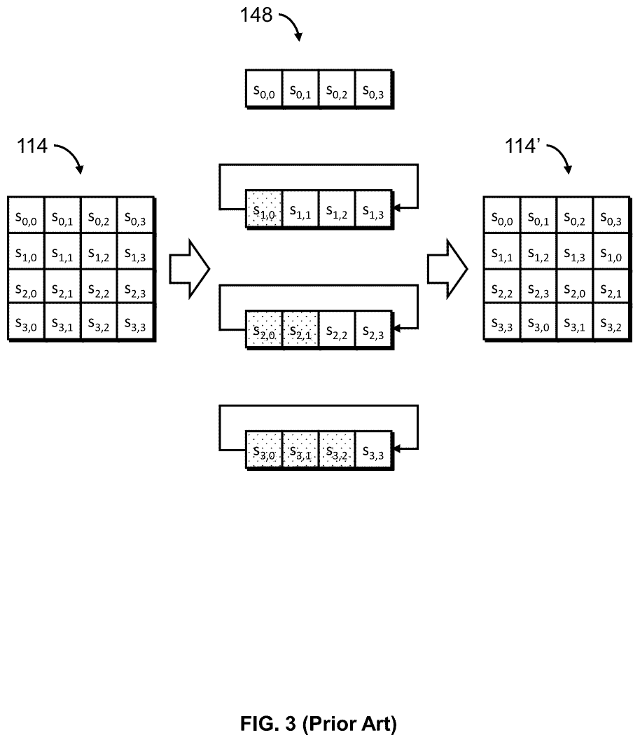

Internally, the AES algorithm is performed on a two-dimensional array of bytes called a state (or a “state array”) 114 (shown in FIG. 3). The state array 114 consists of four rows, each containing Nb bytes, where Nb is the block length divided by 32. In the state array 114 denoted by the symbol s, each individual byte has two indices, with its row number r in the range 0≤r<4 and its column number c in the range 0≤c<Nb. This allows an individual byte of the state array 114 to be referred to as either s_{r,c} or s[r, c]. For conformance to the requirements of AES, Nb=4 (i.e., 0≤c<4).

At the start of a cipher routine 112 and an inverse cipher routine 108, an input (i.e., an array of bytes in₀, in₁, . . . , in₁₅) (not shown) is copied into the state array 114. The encipher routine 112 or the decipher routine 108 are then conducted on the state array 114, after which its final value is copied to an output (i.e., an array of bytes out₀, out₁, . . . , out₁₅) (not shown). Hence, at the beginning of the encipher routine 112 or the decipher routine 108, the input array in (not shown) is copied to the state array 114 according to the scheme:

$$s [ r , c ] = in [ r + 4 c ] for 0 \leq r < 4 and 0 \leq c < Nb$$

and at the end of the encipher routine 112 or the decipher routine 108, the state array 114 is copied to the output array out (not shown) as follows:

$$out [ r + 4 c ] = s [ r , c ] for 0 \leq r < 4 and 0 \leq c < Nb .$$

The key expansion routine 104 includes a Rotate Word (or “RotWord”) transformation 116, a Substitute Word (or “SubWord”) transformation 120, and a Round Constant XOR (or “Rcon XOR”) transformation 124. The key expansion routine 104 accepts as an input the cipher key 850 and generates a plurality of round keys (called a “key schedule”) 852a-n (shown in FIG. 8B). The key expansion routine 104 generates a total of Nb(Nr+1) words: the key expansion routine 104 requires an initial set of Nb words, and each of the Nr rounds requires Nb words of key data. The plurality of round keys 852a-n resulting from the key expansion routine 104 consists of a linear array of four-byte words, denoted [wᵢ], with i in the range 0≤i<Nb(Nr+1).

The RotWord transformation 116 involves taking a four-byte input word [a₀, a₁, a₂, a₃] and performing a cyclic permutation, returning an output word [a₁, a₂, a₃, a₀]. The SubWord transformation 120 involves applying a substitution table (or “S-box” or “lookup table” or “LUT”) (not shown) to each byte of a four-byte input word to produce an output word. The Rcon XOR transformation 124 involves performing a bitwise Exclusive OR (or “XOR”) operation using a four-byte input word and Rcon[i]-a round constant word array—as operands. Rcon[i] contains the values given by [xⁱ⁻¹,{00},{00},{00}], with xⁱ⁻¹ being powers of x (x is denoted as {02}) in the field GF(2⁸), where i represents the current round of the key expansion routine 104, starting at 1.

The first Nk words of the expanded key are filled with the cipher key 850, and every following word w[i] is equal to the output of a XOR operation using the previous word (i.e., w[i−1]) and the word Nk positions earlier (i.e., w[i−Nk]). For words in positions that are a multiple of Nk (i.e., 2*Nk, 3*Nk, etc.), a transformation is applied to w[i−1] prior to the XOR operation, followed by an XOR operation with a round constant Rcon[i]. This transformation consists of the RotWord transformation 116, followed by the SubWord transformation 120.

It is important to note that the key expansion routine 104 for 256-bit cipher keys 850 (i.e., Nk=8) is slightly different than for 128- and 192-bit cipher keys 850. If Nk=8 and i−4 is a multiple of Nk, then the SubWord transformation 120 is applied to w[i−1] prior to the XOR operation.

The encipher routine 112 includes a Substitute Bytes (or “SubBytes”) transformation 128, a Shift Rows (or “ShiftRows”) transformation 132, a Mix Columns (or “MixColumns”) transformation 136, and an Add Round Key (or “AddRoundKey”) transformation 140.

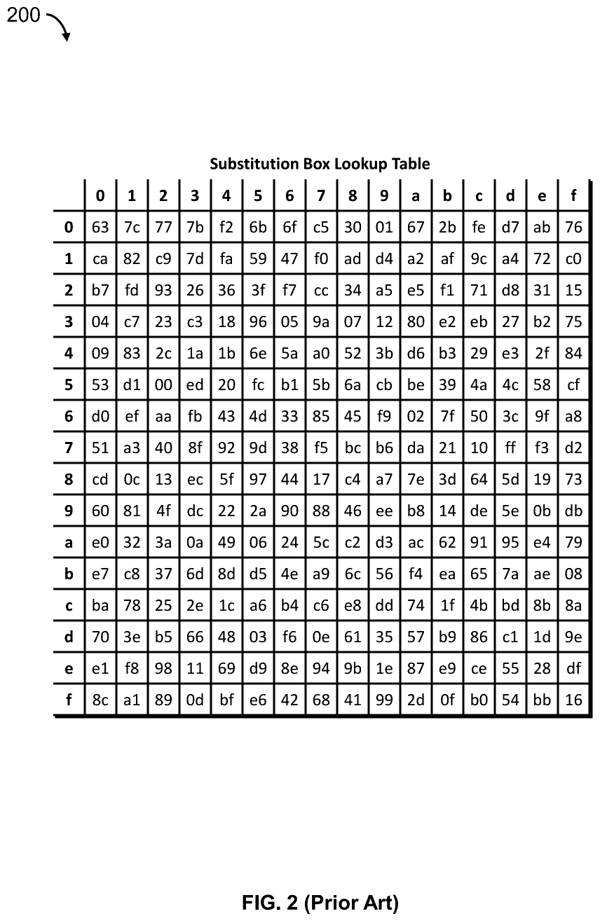

The SubBytes transformation 128 is a non-linear byte substitution that operates independently on each byte of the state array 114 using an S-box 200 (shown in FIG. 2). This S-box 200, which is invertible, is constructed by composing two transformations:
1. Take the multiplicative inverse in the finite field GF(2⁸), mapping the element {00} to itself; and
2. Apply the following affine transformation (over GF(2)):

$${{b}^{′}}_{i} = {b}_{i} ⊕ {b}_{( i + 4 ) mod 8} ⊕ {b}_{( i + 5 ) mod 8} ⊕ {b}_{( i + 6 ) mod 8} ⊕ {b}_{( i + 7 ) mod 8} ⊕ {c}_{i}$$

for 0≤i<8, where bᵢ is the ith bit of the byte b, and cᵢ is the ith bit of a byte c with the value {63} (or {01100011}).

In matrix form, the affine transformation element of the S-box 200 can be expressed as:

$$[ \begin{matrix}{{b}^{′}}_{0} \\ {{b}^{′}}_{1} \\ {{b}^{′}}_{2} \\ {{b}^{′}}_{3} \\ {{b}^{′}}_{4} \\ {{b}^{′}}_{5} \\ {{b}^{′}}_{6} \\ {{b}^{′}}_{7}\end{matrix} ] = [ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] [ \begin{matrix}{b}_{0} \\ {b}_{1} \\ {b}_{2} \\ {b}_{3} \\ {b}_{4} \\ {b}_{5} \\ {b}_{6} \\ {b}_{7}\end{matrix} ] + [ \begin{matrix}1 \\ 1 \\ 0 \\ 0 \\ 0 \\ 1 \\ 1 \\ 0\end{matrix} ] .$$

The S-box 200 used in the SubBytes transformation 128 is presented in hexadecimal form in FIG. 2. For example, if s_{1,1}={53}, then the substitution value would be determined by the intersection of the row with index ‘5’ and the column with index ‘3’. This would result in s_{1,1} having a value of {ed}.

In the ShiftRows transformation 132 (illustrated in FIG. 3), the bytes in the last three rows of the state array 114 are cyclically shifted over different numbers of bytes (or “offsets”). The first row, r=0, is not shifted. Specifically, the ShiftRows transformation 132 proceeds as follows:

$${{s}^{′}}_{r , c} = {s}_{r , ( c + shift ( r , Nb ) ) modNb} for 0 < r < 4 and 0 \leq c < Nb ,$$

where the shift value shift(r, Nb) depends on the row number r as follows:

$$shift ( 1 , 4 ) = 1 ; shift ( 2 , 4 ) = 2 ; shift ( 3 , 4 ) = 3.$$

This has the effect of moving bytes to “lower” positions in the row (i.e., lower values of c in a given row), while the “lowest” bytes wrap around into the “top” of the row (i.e., higher values of c in a given row). Conventionally, this transformation is accomplished using wiring.

The MixColumns transformation 136 operates on the state array 114 column-by-column, treating each column as a four-term polynomial with coefficients in GF(2⁸). The columns are considered as polynomials over GF(2⁸) and multiplied modulo x⁴+1 with a fixed polynomial a(x) given by:

$$a ( x ) = \{ 03 \} {x}^{2} + \{ 01 \} {x}^{2} + \{ 01 \} x + \{ 02 \} .$$

This can be written as a matrix multiplication. Let s′(x)=a(x)⊗s(x) be

$$[ \begin{matrix}{{s}^{′}}_{0 , c} \\ {{s}^{′}}_{1 , c} \\ {{s}^{′}}_{1 , c} \\ {{s}^{′}}_{3 , c}\end{matrix} ] = [ \begin{matrix}02 & 03 & 01 & 01 \\ 01 & 02 & 03 & 01 \\ 01 & 01 & 02 & 03 \\ 03 & 01 & 01 & 01\end{matrix} ] [ \begin{matrix}{s}_{0 , c} \\ {s}_{1 , c} \\ {s}_{2 , c} \\ {s}_{3 , c}\end{matrix} ] for 0 \leq c < nb .$$

As a result of this multiplication, the four bytes in a column are replaced by the following:

$${{s}^{′}}_{0 , c} = ( \{ 02 \} \cdot {s}_{0 , c} ) ⊕ ( \{ 03 \} \cdot {s}_{1 , c} ) ⊕ {s}_{2 , c} ⊕ {s}_{3 , c} ;$$

$${{s}^{′}}_{1 , c} = ( \{ 02 \} \cdot {s}_{1 , c} ) ⊕ ( \{ 03 \} \cdot {s}_{2 , c} ) ⊕ {s}_{0 , c} ⊕ {s}_{3 , c} ;$$

$${{s}^{′}}_{2 , c} = ( \{ 02 \} \cdot {s}_{2 , c} ) ⊕ ( \{ 03 \} \cdot {s}_{3 , c} ) ⊕ {s}_{0 , c} ⊕ {s}_{1 , c} ;$$

$${{s}^{′}}_{3 , c} = ( \{ 02 \} \cdot {s}_{3 , c} ) ⊕ ( \{ 03 \} \cdot {s}_{0 , c} ) ⊕ {s}_{1 , c} ⊕ {s}_{2 , c} .$$

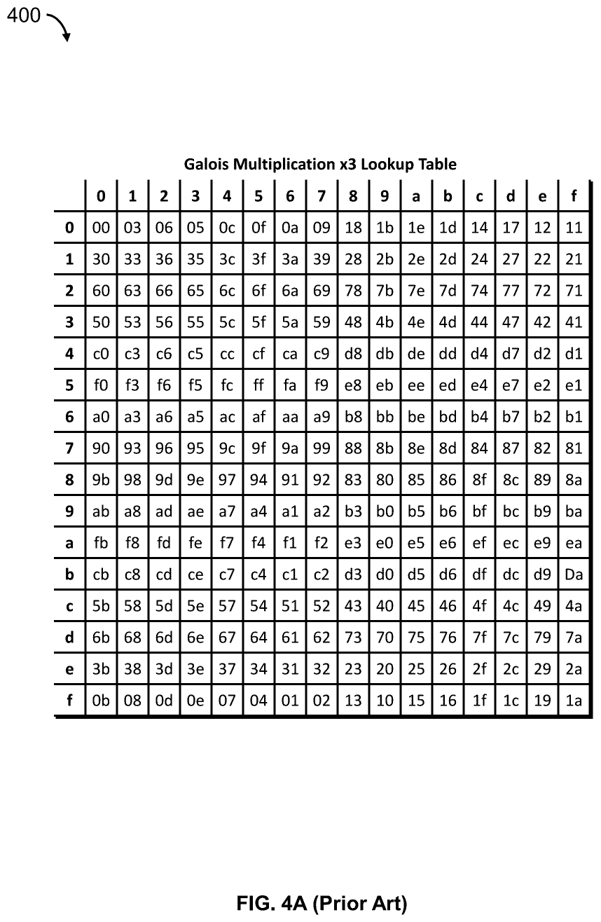

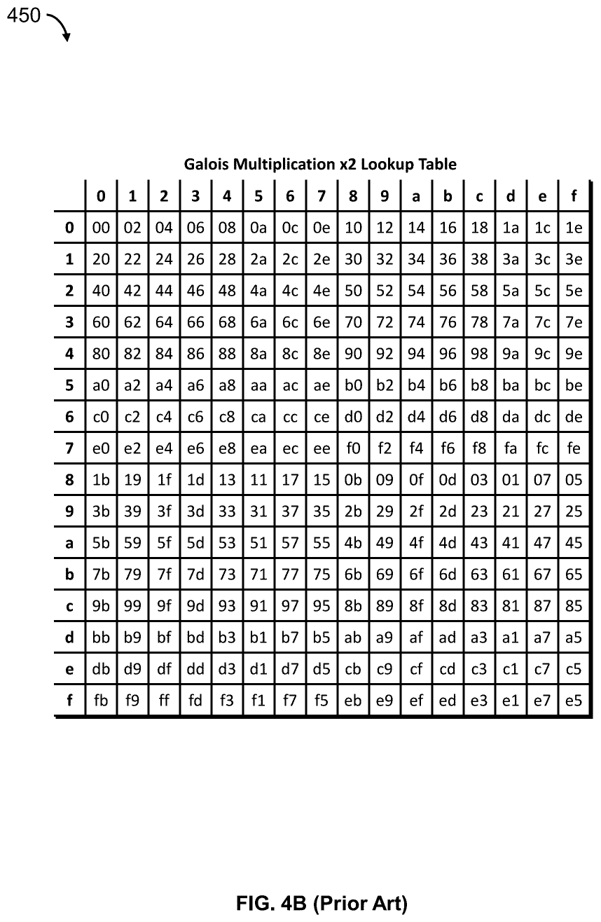

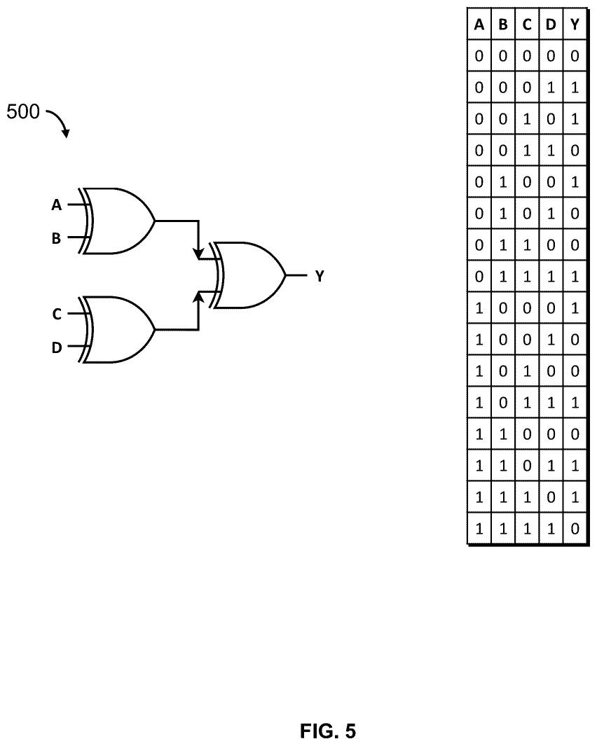

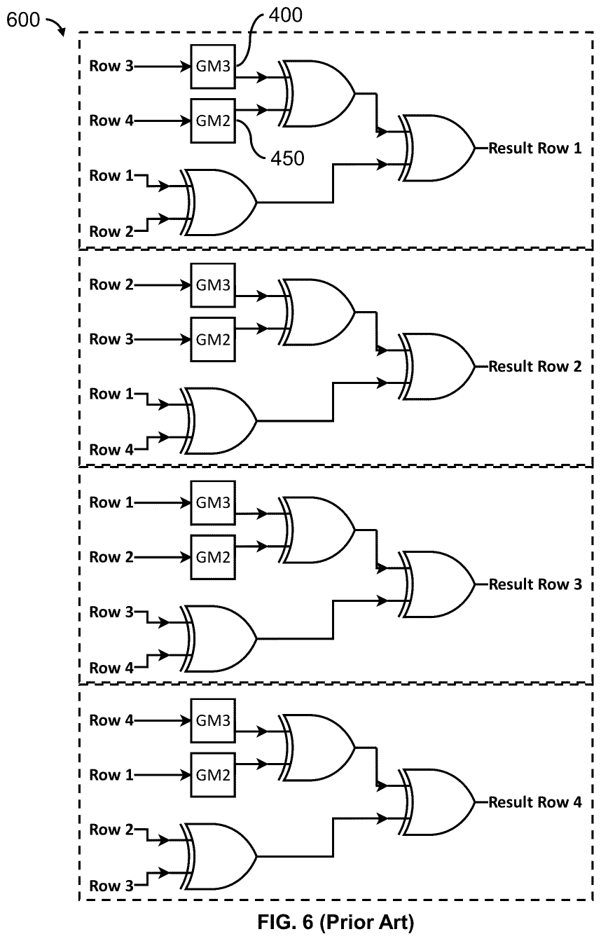

Conventionally, rather than by performing the multiplication as described above, the MixColumns transformation 136 is accomplished through the implementation of pre-calculated lookup tables. Specifically, the MixColumns transformation 136 is accomplished through the implementation of a Galois Multiplication ×3 lookup table 400 (shown in FIG. 4A) constructed using a Galois Field multiplication by three and a Galois Multiplication ×2 lookup table 450 (shown in FIG. 4B) constructed using a Galois Field multiplication by two, both in GF(2⁸) with a modulus of x⁴+1, followed by a series of XOR operations equivalent in function to an even parity checker 500 (shown in FIG. 5). A MixColumns subassembly 600 implemented in the conventional manner is shown in FIG. 6. For purposes of brevity, only one instance of each of the Galois Multiplication ×3 lookup table 400 and the Galois Multiplication ×2 lookup table 450 are labeled with reference numbers.

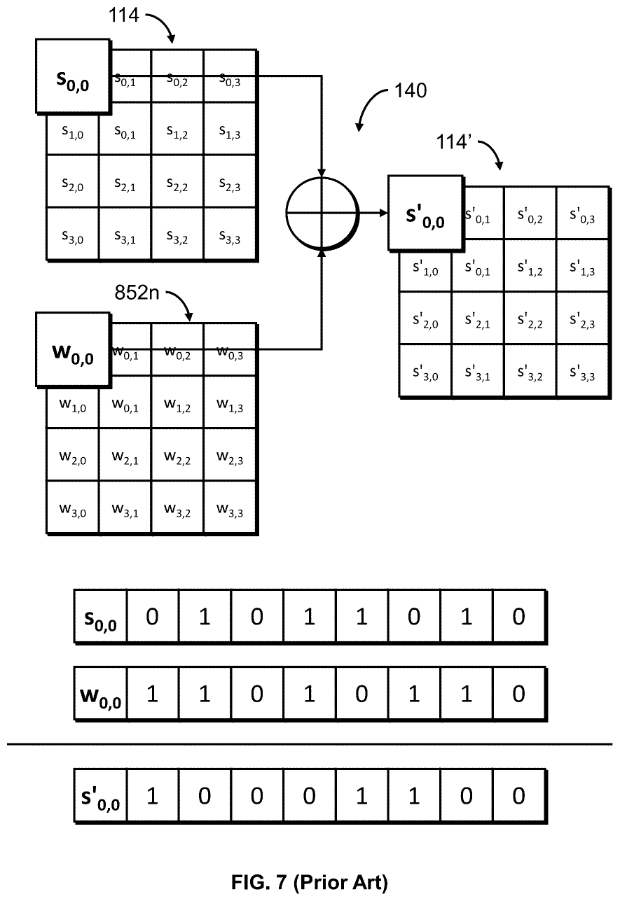

In the AddRoundKey transformation 140 (illustrated in FIG. 7), a round key 852n is added to the state array 114 by a simple bitwise XOR operation. Each of the plurality of round keys 852a-n consists of Nb words. Those Nb words are each added into the columns of the state array 114, such that

$$[ {{s}^{′}}_{0 , c} , {{s}^{′}}_{1 , c} , {{s}^{′}}_{2 , c} , {{s}^{′}}_{3 , c} ] = [ {s}_{0 , c} , {s}_{1 , c} , {s}_{2 , c} , {s}_{3 , c} ] ⊕ [ {w}_{round * Nb + c} ] for 0 \leq c < Nb ,$$

where wᵢ are the plurality of round keys 852a-n, and round is a value in the range 0≤round≤Nr. In the encipher routine 112, the initial addition of the round key 852n occurs when round=0, prior to the first performance of the SubBytes transformation 128, the ShiftRows transformation 132, and the MixColumns transformation 136. The application of the AddRoundKey transformation 140 to the Nr rounds of the encipher routine 112 occurs when 1≤round≤Nr.

The decipher routine 108 includes the AddRoundKey transformation 140, an Inverse Mix Columns (or “InvMixColumns”) transformation 144, an Inverse Shift Rows (or “InvShiftRows”) transformation 148, and an Inverse Substitute Bytes (or “InvSubBytes”) transformation 152.

The InvShiftRows transformation 148 is the inverse of the ShiftRows transformation 132. The bytes in the last three rows of the state array 114 are cyclically shifted over different numbers of bytes (or “offsets”). The first row, r=0, is not shifted. The bottom three rows are cyclically shifted by Nb−shift(r, Nb) bytes, where the shift value shift(r, Nb) depends on the row number.

Specifically, the InvShiftRows transformation 148 proceeds as follows:

$${{s}^{′}}_{r , ( c + shift ( r , Nb ) ) modNb} = {s}_{r , c} for 0 < r < 4 and 0 \leq c < Nb .$$

The InvSubBytes transformation 152 is the inverse of the SubBytes transformation 128, in which the inverse S-box (not shown) is applied to each byte of the state array 114. This is obtained by applying the inverse of the affine transformation followed by taking the multiplicative inverse in GF(2⁸).

The InvMixColumns transformation 144 is the inverse of the MixColumns transformation 136. The InvMixColumns transformation 144 operates on the state array 114 column-by-column, treating each column as a four-term polynomial. The columns are considered as polynomials over GF(2⁸) and multiplied modulo x⁴+1 with a fixed polynomial a⁻¹(x), given by

$${a}^{- 1} ( x ) = \{ 0 b \} {x}^{3} + \{ 0 d \} {x}^{2} + \{ 09 \} x + \{ 0 e \} .$$

This can be written as a matrix multiplication. Let s′(x)=a⁻¹(x)⊗s(x) be

$$[ \begin{matrix}{{s}^{′}}_{0 , c} \\ {{s}^{′}}_{1 , c} \\ {{s}^{′}}_{1 , c} \\ {{s}^{′}}_{3 , c}\end{matrix} ] = [ \begin{matrix}0 e & 0 b & 0 d & 09 \\ 09 & 0 e & 0 b & 0 d \\ 0 d & 09 & 0 e & 0 b \\ 0 b & 0 d & 09 & 0 e\end{matrix} ] [ \begin{matrix}{s}_{0 , c} \\ {s}_{1 , c} \\ {s}_{2 , c} \\ {s}_{3 , c}\end{matrix} ] for 0 \leq c < Nb .$$

As a result of this multiplication, the four bytes in a column are replaced by the following:

$${{s}^{′}}_{0 , c} = ( \{ 0 e \} \cdot {s}_{0 , c} ) ⊕ ( \{ 0 b \} \cdot {s}_{1 , c} ) ⊕ ( \{ 0 d \} \cdot {s}_{2 , c} ) ⊕ ( \{ 09 \} \cdot {s}_{3 , c} ) ;$$

$${{s}^{′}}_{0 , c} = ( \{ 09 \} \cdot {s}_{0 , c} ) ⊕ ( \{ 0 e \} \cdot {s}_{1 , c} ) ⊕ ( \{ 0 b \} \cdot {s}_{2 , c} ) ⊕ ( \{ 0 d \} \cdot {s}_{3 , c} ) ;$$

$${{s}^{′}}_{0 , c} = ( \{ 0 d \} \cdot {s}_{0 , c} ) ⊕ ( \{ 09 \} \cdot {s}_{1 , c} ) ⊕ ( \{ 0 e \} \cdot {s}_{2 , c} ) ⊕ ( \{ 0 b \} \cdot {s}_{3 , c} ) ;$$

$${{s}^{′}}_{0 , c} = ( \{ 0 b \} \cdot {s}_{0 , c} ) ⊕ ( \{ 0 d \} \cdot {s}_{1 , c} ) ⊕ ( \{ 09 \} \cdot {s}_{2 , c} ) ⊕ ( \{ 0 e \} \cdot {s}_{3 , c} ) .$$

The AddRoundKey transformation 140 is its own inverse since it only involves an application of a bitwise XOR operation.

Turning to the inventive concept(s), and in particular FIG. 8A, shown therein is an embodiment of an implementation of a cryptographic primitive 800 conforming to the requirements of AES operable to perform a novel encipher routine 804 in accordance with the present disclosure. The presently disclosed cryptographic primitive 800 improves on the prior art implementation of AES 100 by providing an optimization in terms of, for example, power consumption and delay. That is, the presently disclosed cryptographic primitive 800 is capable of encrypting and decrypting data messages at increased speeds (using fewer clock cycles or taking less time per clock cycle) while consuming less energy. In the presently disclosed cryptographic primitive 800, the key expansion routine 104 and the decipher routine 108 function according to the prior art implementation of AES 100, as described above. However, in the presently disclosed cryptographic primitive 800, the encipher routine 112 of the prior art implementation of AES 100 is replaced with the novel encipher routine 804.

The novel encipher routine 804 includes the ShiftRows transformation 132, a combined SubBytes and MixColumns transformation 808, and the AddRoundKey transformation 140. The ShiftRows transformation 132 and the AddRoundKey transformation 140 of the novel encipher routine 804 function according to the prior art implementation of AES 100, as described above. However, in the presently disclosed cryptographic primitive 800, the SubBytes transformation 128 and the MixColumns transformation 136 of the prior art implementation of AES 100 are replaced with the combined SubBytes and MixColumns transformation 808.

In the novel encipher routine 804, the transformations may be performed in the order: (1) the ShiftRows transformation 132; (2) the combined SubBytes and MixColumns transformation 808; and (3) the AddRoundKey transformation 140. This order replaces that of the encipher routine 112 of the prior art implementation of AES 100, in which the transformations are performed in the order: (1) the SubBytes transformation 128; (2) the ShiftRows transformation 132; (3) the MixColumns transformation 136; and (4) the AddRoundKey transformation 140.

It is important to note that the ShiftRows transformation 132 and the SubBytes transformation 128 of the encipher routine 112 of the prior art implementation of AES 100 are commutative; therefore, they may be re-arranged such that the SubBytes transformation 128 and the MixColumns transformation 136 are performed sequentially without affecting the output. Put another way, the transformations may be rearranged such that they are performed in the order: (1) the ShiftRows transformation 132; (2) the SubBytes transformation 128; (3) the MixColumns transformation 136; and (4) the AddRoundKey transformation 140. Re-arranging the transformations of the encipher routine 112 of the prior art implementation of AES 100 such that the SubBytes transformation 128 and the MixColumns transformation 136 are performed sequentially allows for the two transformations to be replaced with the combined SubBytes and MixColumns transformation 808 of the novel encipher routine 804 of the presently disclosed cryptographic primitive 800.

Turning now to FIG. 8B, shown therein is a block diagram of a computer system 812 implementing the presently disclosed cryptographic primitive 800, as described above. The computer system 812 may be implemented as a desktop computer, a laptop computer, a smartphone, a computer tablet, a computer kiosk, an embedded computer, a wireless router, an Application Specific Integrated Circuit (ASIC), or other computing devices, for example. The computer system 812 may include one or more non-transitory computer readable medium 816, a cryptographic device 820, one or more processor 824, a network device 828, an input device 832, and an output device 836.

The one or more non-transitory computer readable medium 816 may be implemented as a conventional non-transitory memory, such as, for example, random access memory (RAM), a hard drive, a solid-state drive, a flash drive, a memory card, a non-transitory optical drive, and/or combinations thereof. The one or more non-transitory computer readable medium 816 may be implemented as a “cloud memory” (i.e., the one or more non-transitory computer readable medium 816 may be partially or completely based on or accessed using a network 840, which is discussed in more detail below). The one or more non-transitory computer readable medium 816 may be located in the same or in a different physical location than other computer system components. When located in a different physical location, the one or more non-transitory computer readable medium 816 may communicate with the other components, for example, via the network 840. The one or more non-transitory computer readable medium 816 may store, for example, one or more computer executable instruction 844 (e.g., software instruction), a plaintext 848, a cipher key 850, a plurality of round keys 852a-n, and a ciphertext 856.

The one or more processor 824 may be implemented as a single processor or a system of multiple processors working together or independently to execute the one or more computer executable instruction 844. The one or more processor 824 may be, for example, a digital signal processor (DSP), a central processing unit (CPU), a graphics processing unit (GPU), a field programmable gate array (FPGA), a microprocessor, a multi-core processor, and/or combinations thereof. The one or more processor 824 may be capable of communicating with the one or more non-transitory computer readable medium 816. It is to be understood that in certain embodiments where the one or more processor 824 is a system of multiple processors, the multiple processors may be located remotely from one another, may be located in the same location, or may comprise a unitary multi-core processor. The one or more processor 824 may be capable of reading and/or executing the one or more computer executable instruction 844 (e.g., software instruction) and/or retrieving, creating, manipulating, altering, and/or storing data in the one or more non-transitory computer readable medium 816.

In certain embodiments where the one or more processor 824 is a system of multiple processors, the one or more processor 824 may be configured to utilize parallelization in order to implement the presently disclosed cryptographic primitive 800. That is, where the one or more processor 824 is a system of multiple processors, the one or more processor 824 may be configured to separate a data message (e.g., the plaintext 848) into a plurality of data chunks such that each of the one or more processor 824 may operate on a particular one of the plurality of data chunks substantially simultaneously in order to implement the presently disclosed cryptographic primitive 800.

The network device 828 may be configured to enable the computer system 812 to connect to the network 840. The network 840 may be, for example, the World Wide Web (or Internet), a local area network (LAN), a wide area network (WAN), a metropolitan network, a wireless network, a cellular network, a Global System for Mobile Communications (GSM) network, a code division multiple access (CDMA) network, a 3G network, a 4G network, a 5G network, a satellite network, a radio network, an optical network, a cable network, a public switched telephone network, an Ethernet network, and/or combinations thereof. It is contemplated that implementations of the present disclosure may use more advanced networking topologies.

The input device 832 may be implemented as, for example, a keyboard, a touchscreen, a mouse, a trackball, a microphone, a fingerprint reader, an infrared port, a cell phone, a personal digital assistant (PDA), a controller, a network interface, speech recognition system, gesture recognition system, eye-tracking system, brain-computer interface system, and/or combinations thereof, for example. The input device 832 may be operable to receive, for example, the plaintext 848 and the cipher key 850 stored in the one or more non-transitory computer readable medium 816.

The output device 836 may be implemented as and/or be part of, for example, a computer monitor, a screen, a touchscreen, a speaker, a website, a television set, an augmented reality system, a smart phone, a personal digital assistant (PDA), a cell phone, a network interface, a fax machine, a printer, a laptop computer, an optical head-mounted display (OHMD), a hologram, and/or combinations thereof, for example. The output device 836 may be operable to transmit, for example, the cipher key 850 and the ciphertext 856 stored in the one or more non-transitory computer readable medium 816.

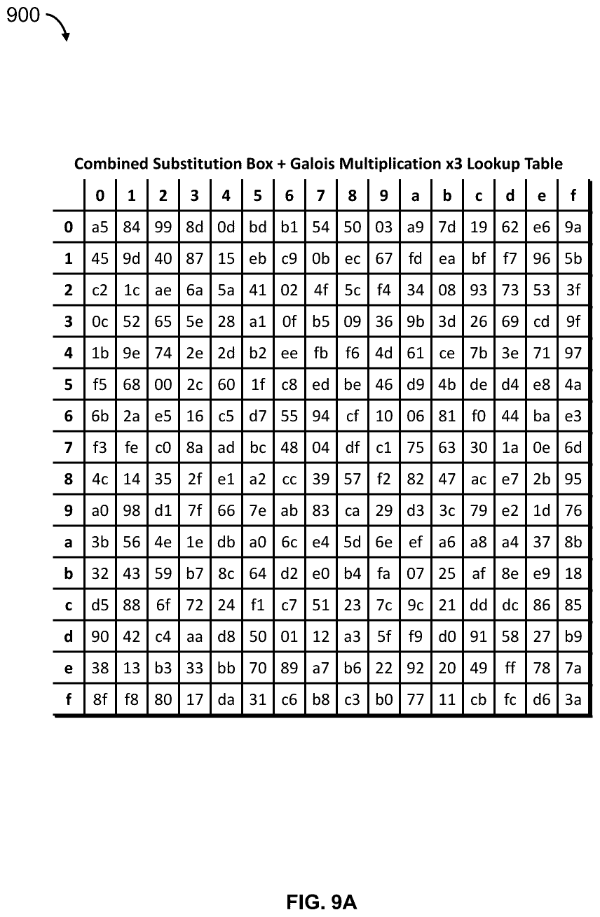

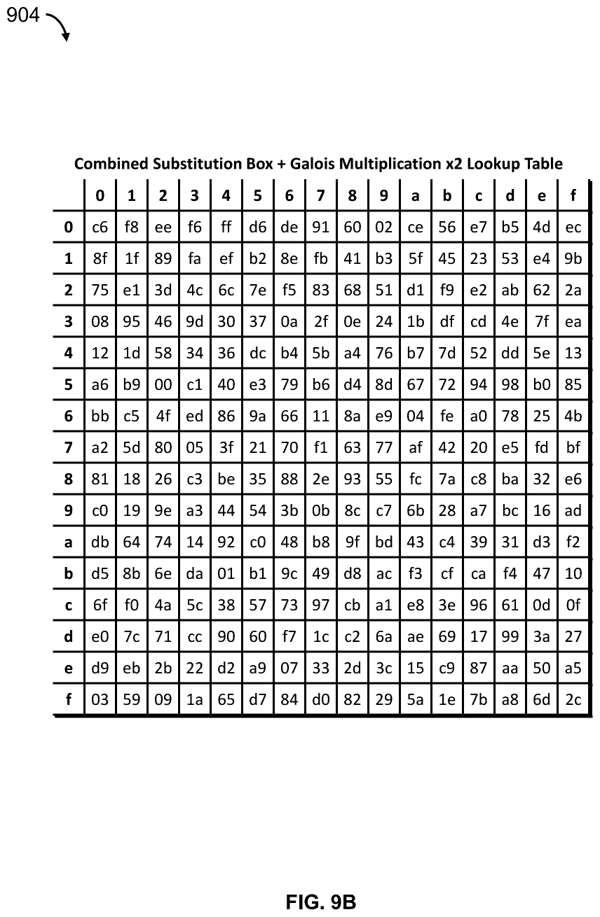

The plaintext 848 may be a data message having sixteen bytes arranged into four plaintext rows including a first plaintext row, a second plaintext row, a third plaintext row, and a fourth plaintext row, each of the plaintext rows having four bytes. Each particular round key 852n of the plurality of round keys 852a-n may be a cryptographic key having sixteen bytes. The ciphertext 856 may be an encrypted data message having sixteen bytes. In one embodiment, the one or more non-transitory computer readable medium 816 may store a combined SubBytes and Galois Multiplication ×3 lookup table 900 (shown in FIG. 9A) and a combined SubBytes and Galois Multiplication ×2 lookup table 904 (shown in FIG. 9B).

The combined SubBytes and Galois Multiplication ×3 lookup table 900 may be constructed by performing the SubBytes transformation 128 as described above, followed by a multiplication in GF(2⁸) by three modulo x⁴+1. Put another way, the combined SubBytes and Galois Multiplication ×3 lookup table 900 may be constructed by taking the values of the S-box 200 used in the SubBytes transformation 128 and using the values as indices for the Galois Multiplication ×3 lookup table 400 used in the MixColumns transformation 136 to produce the combined SubBytes and Galois Multiplication ×3 lookup table 900.

The combined SubBytes and Galois Multiplication ×2 lookup table 904 may be constructed by performing the SubBytes transformation 128 as described above, followed by a multiplication in GF(2⁸) by two modulo x⁴+1. Put another way, the combined SubBytes and Galois Multiplication ×2 lookup table 904 may be constructed by taking the values of the S-box 200 used in the SubBytes transformation 128 and using the values as indices for the Galois Multiplication ×2 lookup table 450 used in the MixColumns transformation 136 to produce the combined SubBytes and Galois Multiplication ×2 lookup table 904.

The combined SubBytes and Galois Multiplication ×3 lookup table 900 and the combined SubBytes and Galois Multiplication ×2 lookup table 904 may each have 256 values, each of the 256 values having one byte.

The cryptographic device 820 may include a key expansion core 868, a decipher core 884, and the novel encipher core 908. The key expansion core 868 and the decipher core 884 may be operable to perform the key expansion routine 104 and the decipher routine 108 of the prior art implementation of AES 100, respectively. The novel encipher core 908 may be operable to perform the novel encipher routine 804 of the presently disclosed cryptographic primitive 800. The novel encipher core 908 may comprise a ShiftRows subassembly 860, a combined SubBytes and MixColumns subassembly 862, and an AddRoundKey subassembly 864.

The ShiftRows subassembly 860 may be operable to shift the bytes of the plaintext 848 in accordance with a ShiftRows transformation 132 conforming to the requirements of AES, as described above. The ShiftRows subassembly 860 may be operable to shift the bytes of the plaintext 848 such that the first plaintext row is shifted by zero bytes, the second plaintext row is shifted by one byte, the third plaintext row is shifted by two bytes, and the fourth plaintext row is shifted by three bytes.

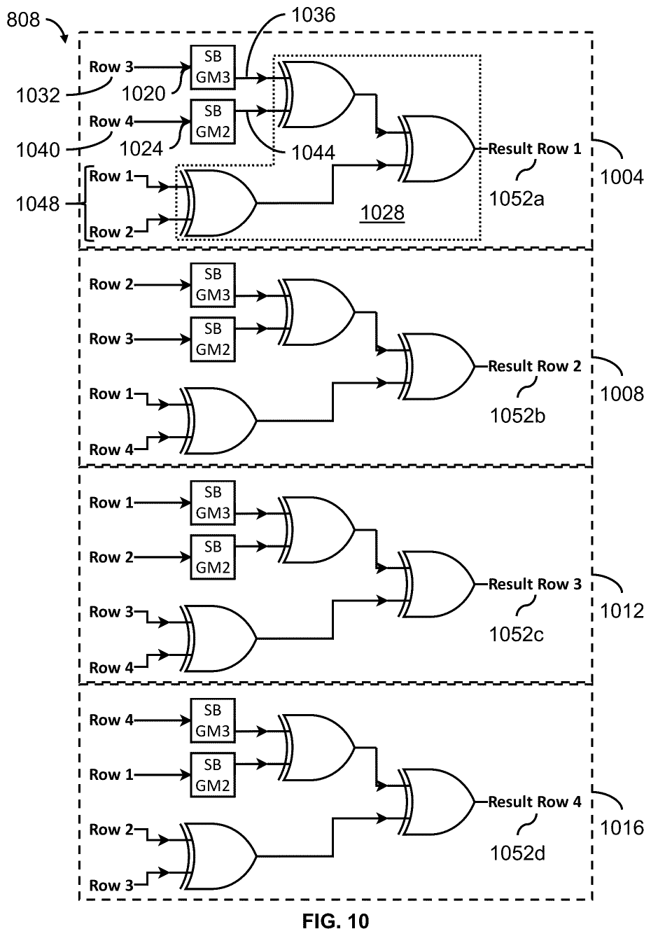

The combined SubBytes and MixColumns subassembly 862 (shown in FIG. 10) may include four combined SubBytes and MixColumns modules 1004, 1008, 1012, and 1016, each of the combined SubBytes and MixColumns modules 1004, 1008, 1012, and 1016 including a first data conversion engine 1020, a second data conversion engine 1024, and a bitwise even parity checker 1028. For purposes of brevity, only one instance of each of the first data conversion engine 1020, the second data conversion engine 1024, and the bitwise even parity checker 1028 are labeled with reference numbers.

The first data conversion engine 1020 may be operable to convert a first portion 1032 of the plaintext 848 into a first result 1036 using the combined SubBytes and Galois Multiplication ×3 lookup table 900. The second data conversion engine 1024 may be operable to convert a second portion 1040 of the plaintext 848 into a second result 1044 using the combined SubBytes and Galois Multiplication ×2 lookup table 904. The bitwise even parity checker 1028 may be operable to accept as operands the first result 1036, the second result 1044, and a third portion 1048 of the plaintext 848, and to produce a result array row 1052a-d. For purposes of brevity, only one instance of each of the first portion 1032 of the plaintext 848, the first result 1036, the second portion 1040 of the plaintext 848, the second result 1044, and the third portion 1048 of the plaintext 848 are labeled with reference number.

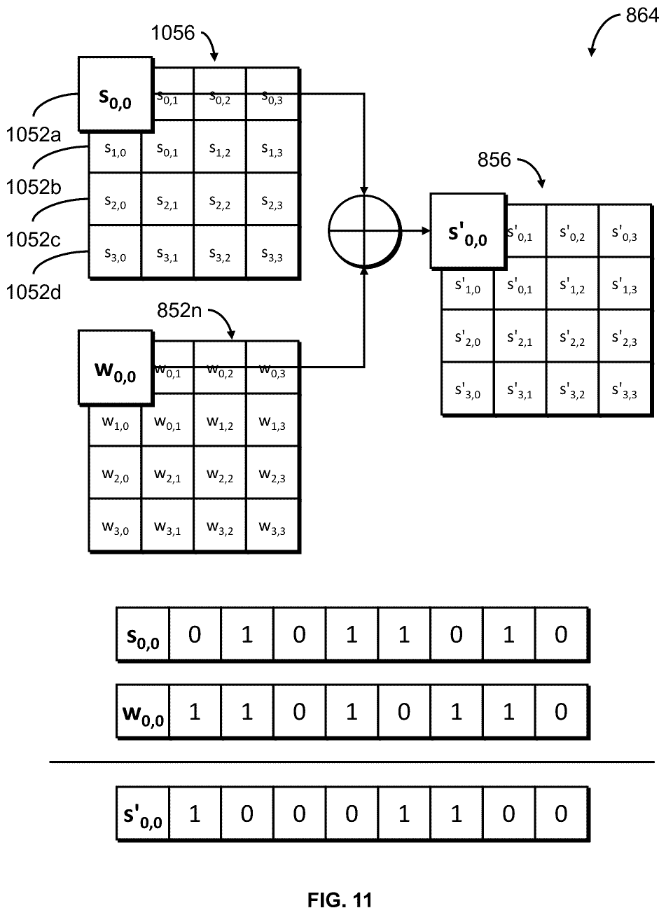

The AddRoundKey subassembly 864 (illustrated in FIG. 11) may include a bitwise XOR engine operable to accept as operands a result array 1056 formed by the result array row 1052a-d from each of the four combined SubBytes and MixColumns modules 1004, 1008, 1012, and 1016, and a particular round key 852n of the plurality of round keys 852a-n to produce a ciphertext 856 indicative of the plaintext 848, wherein the combined SubBytes and MixColumns subassembly 862 conforms to the requirements of AES such that the ciphertext 856 can be reverted to the plaintext 848 using the decipher core 884 (or any decipher core conforming to the requirements of AES).

In one embodiment, the one or more computer executable instruction 844 may, when executed by the processor 824, cause the processor 824 to operate the novel encipher core 908 in order to: store a plaintext 848 and a particular round key 852n of a plurality of round keys 852a-n in the one or more non-transitory computer readable medium 816, the plaintext 848 being a data message to be encrypted having a plurality of bytes and the particular round key 852n of the plurality of round keys 852a-n being an encryption key having a plurality of bytes; shifting the bytes of the plaintext 848 in accordance with a ShiftRows transformation 132 conforming to the requirements of AES; populating four result array rows 1052a-d of a result array 1056 using the plaintext 848; and adding the particular round key 852n to the result array 1056 in accordance with an AddRoundKey transformation 140 conforming to the requirements of AES to produce a ciphertext 856 indicative of the plaintext 848.

Populating a result array row 1052a-n may include: converting a first portion 1032 of the plaintext 848 into a first result 1036 using the combined SubBytes and Galois Multiplication ×3 lookup table 900; converting a second portion 1040 of the plaintext 848 into a second result 1044 using the combined SubBytes and Galois Multiplication ×2 lookup table 904; and performing a bitwise even parity check, using as operands the first result 1036, the second result 1044, and a third portion 1048 of the plaintext 848 to produce the result array row 1052a-d. The step of producing the four result array rows 1052a-d of the result array 1056 using the plaintext 848 may conform to the requirements of AES such that the ciphertext 856 can be reverted to the plaintext 848 using the decipher core 884 (or any decipher core conforming to the requirements of AES). The steps described above may be repeated by the processor 824 using a new round key 852n of the plurality of round keys 852a-n until each of the plurality of round keys 852a-n has been used.

The novel encipher core 908 may further comprise a finite state machine (not shown) having a plurality of predetermined states including a ShiftRows state, wherein the ShiftRows subassembly 860 is operated to shift the bytes of the plaintext 848 in accordance with the ShiftRows transformation 132; a combined SubBytes and MixColumns state, wherein the combined SubBytes and MixColumns subassembly 862 is operated to produce the result array 1056; and an AddRoundKey state, wherein the AddRoundKey subassembly 864 is operated to add a particular round key 852n of the plurality of round keys 852a-n to the result array 1056 in accordance with the AddRoundKey transformation 140 to produce the ciphertext 856. The finite state machine (not shown) may be operable to transition between the plurality of predetermined states in response to the detection of a trigger event. The trigger event may be indicative of the completion of a transformation by one of the ShiftRows subassembly 860, the combined SubBytes and MixColumns subassembly 862, and the AddRoundKey subassembly 864.

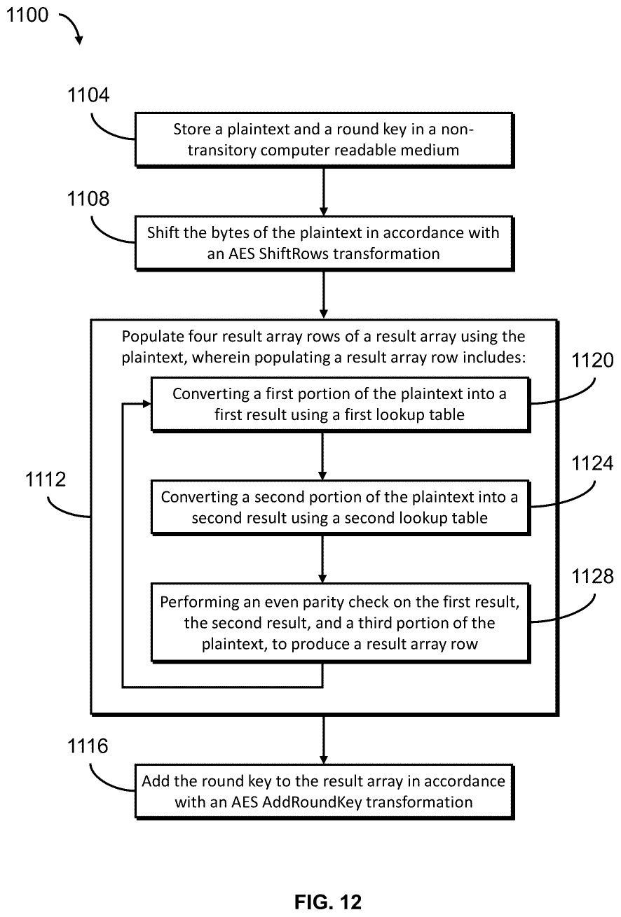

In another embodiment, the cryptographic primitive 800 is a novel encipher method 1100 comprising computer executable instructions (e.g., software instructions) (shown in FIG. 12) comprising the steps of: storing a plaintext 848 and a particular round key 852n of a plurality of round keys 852a-n in one or more non-transitory computer readable medium 816 (1104), the plaintext 848 being a data message to be encrypted having a plurality of bytes and the particular round key 852n of the plurality of round keys 852a-n being an encryption key having a plurality of bytes; shifting the bytes of the plaintext 848 in accordance with a ShiftRows transformation 132 conforming to the requirements of AES (1108); populating four result array rows 1052a-d of a result array 1056 using the plaintext 848 (1112); and adding the particular round key 852n to the result array 1056 in accordance with an AddRoundKey transformation 140 conforming to the requirements of AES to produce a ciphertext 856 indicative of the plaintext 848 (1116).

Populating a result array row 1052a-n may include: converting a first portion 1032 of the plaintext 848 into a first result 1036 using the combined SubBytes and Galois Multiplication ×3 lookup table 900 (1120); converting a second portion 1040 of the plaintext 848 into a second result 1044 using the combined SubBytes and Galois Multiplication ×2 lookup table 904 (1124); and performing a bitwise even parity check, using as operands the first result 1036, the second result 1044, and a third portion 1048 of the plaintext 848 to produce the result array row 1052a-d (1128). The step of producing the four result array rows 1052a-d of the result array 1056 using the plaintext 848 may conform to the requirements of AES such that the ciphertext 856 can be reverted to the plaintext 848 using the decipher core 884 (or any decipher core conforming to the requirements of AES). The novel encipher method 1100 may be repeated using a new round key 852n of the plurality of round keys 852a-n until each of the plurality of round keys 852a-n has been used.

In certain embodiments, the novel encipher method 1100 may be performed utilizing parallelization. That is, the novel encipher method 1100 may further include separating a data message (e.g., the plaintext 848) into a plurality of data chunks such that each of the plurality of data chunks may be operated on substantially simultaneously.

The following is a list of non-limiting illustrative embodiments of the inventive concept disclosed herein:

1. An encipher core, comprising:
a non-transitory computer-readable medium storing a first lookup table, a second lookup table, a plaintext, and a round key, the first lookup table constructed by performing a byte substitution in accordance with a SubBytes transformation conforming to requirements of an Advanced Encryption Standard followed by a multiplication in GF(2⁸) by three modulo x⁴+1, the second lookup table constructed by performing the byte substitution in accordance with the SubBytes transformation conforming to the requirements of the Advanced Encryption Standard followed by a multiplication in GF(2⁸) by two modulo x⁴+1, the plaintext being a data message to be encrypted having a plurality of bytes, the round key being a cipher key having a plurality of bytes;
a ShiftRows subassembly operable to shift the bytes of the plaintext in accordance with a ShiftRows transformation conforming to the requirements of the Advanced Encryption Standard;
a combined SubBytes and MixColumns subassembly including four combined SubBytes and MixColumns modules, each of the combined SubBytes and MixColumns modules including:
   a first data conversion engine operable to convert a first portion of the plaintext into a first result using the first lookup table;
   a second data conversion engine operable to convert a second portion of the plaintext into a second result using the second lookup table; and
   a bitwise even parity checker operable to accept as operands the first result, the second result, and a third portion of the plaintext to produce a result array row; and
an AddRoundKey subassembly operable to add the round key to the result array in accordance with an AddRoundKey transformation conforming to the requirements of the Advanced Encryption Standard to produce a ciphertext indicative of the plaintext, the result array formed by the result array rows from the four combined SubBytes and MixColumns modules, wherein the combined SubBytes and MixColumns subassembly conforms to the requirements of the Advanced Encryption Standard such that the ciphertext can be reverted to the plaintext using a decipher core conforming to the requirements of the Advanced Encryption Standard.

2. The encipher core of illustrative embodiment 1, wherein the first lookup table has 256 first values, each of the 256 first values having one byte, and the second lookup table has 256 second values, each of the 256 second values having one byte.

3. The encipher core of any of illustrative embodiments 1-2, further comprising a finite state machine having a plurality of predetermined states including:
a ShiftRows state, wherein the ShiftRows subassembly is operated to shift the bytes of the plaintext in accordance with the ShiftRows transformation;
a combined SubBytes and MixColumns state, wherein the combined SubBytes and MixColumns subassembly is operated to produce the result array; and
an AddRoundKey state, wherein the AddRoundKey subassembly is operated to add the round key to the result array in accordance with the AddRoundKey transformation to produce the ciphertext, wherein the finite state machine is operable to transition between the plurality of predetermined states in response to detection of a trigger event.

4. The encipher core of illustrative embodiment 3, wherein the trigger event is indicative of the completion of a transformation by one of the ShiftRows subassembly, the combined SubBytes and MixColumns subassembly, and the AddRoundKey subassembly.

5. The encipher core of illustrative embodiment 1, wherein the plaintext has 16 bytes arranged into four plaintext rows including a first plaintext row, a second plaintext row, a third plaintext row, and a fourth plaintext row, each of the plaintext rows having four bytes, and the round key has 16 bytes.

6. The encipher core of illustrative embodiment 5, wherein the ShiftRows subassembly is operable to shift the bytes of the plaintext such that the first plaintext row is shifted by zero bytes, the second plaintext row is shifted by one byte, the third plaintext row is shifted by two bytes, and the fourth plaintext row is shifted by three bytes.

7. The encipher core of illustrative embodiment 5, wherein the combined SubBytes and MixColumns modules includes a first combined SubBytes and MixColumns module, a second combined SubBytes and MixColumns module, a third combined SubBytes and MixColumns module, and a fourth combined SubBytes and MixColumns module, wherein:
the first portion of the plaintext operated on by the first combined SubBytes and MixColumns module is the fourth plaintext row;
the second portion of the plaintext operated on by the first combined SubBytes and MixColumns module is the third plaintext row;
the third portion of the plaintext operated on by the first combined SubBytes and MixColumns module includes the first plaintext row and the second plaintext row;
the first portion of the plaintext operated on by the second combined SubBytes and MixColumns module is the third plaintext row;
the second portion of the plaintext operated on by the second combined SubBytes and MixColumns module is the second plaintext row;
the third portion of the plaintext operated on by the second combined SubBytes and MixColumns module includes the first plaintext row and the fourth plaintext row;
the first portion of the plaintext operated on by the third combined SubBytes and MixColumns module is the second plaintext row;
the second portion of the plaintext operated on by the third combined SubBytes and MixColumns module is the first plaintext row;
the third portion of the plaintext operated on by the third combined SubBytes and MixColumns module includes the third plaintext row and the fourth plaintext row;
the first portion of the plaintext operated on by the fourth combined SubBytes and MixColumns module is the first plaintext row;
the second portion of the plaintext operated on by the fourth combined SubBytes and MixColumns module is the fourth plaintext row; and the third portion of the plaintext operated on by the first combined SubBytes and MixColumns module includes the third plaintext row and the second plaintext row.

8. A non-transitory computer readable medium having software instructions stored thereon that, when executed by a processor, cause the processor to:
receive a plaintext and a round key, the plaintext being a data message to be encrypted having a plurality of bytes, the round key being an encryption key having a plurality of bytes;
shift the bytes of the plaintext in accordance with a ShiftRows transformation conforming to requirements of an Advanced Encryption Standard;
populate four result array rows of a result array, wherein populating a result array row of the four result array rows includes:
   converting a first portion of the plaintext into a first result using a first lookup table, the first lookup table constructed by performing a byte substitution in accordance with a SubBytes transformation conforming to the requirements of an Advanced Encryption Standard, followed by a multiplication in GF(2⁸) by three modulo x⁴+1;
   converting a second portion of the plaintext into a second result using a second lookup table, the second lookup table constructed by performing a byte substitution in accordance with the SubBytes transformation, followed by a multiplication in GF(2⁸) by two modulo x⁴+1; and
   performing a bitwise even parity check, using as operands the first result, the second result, and a third portion of the plaintext to produce the result array row; and
add the round key to the result array in accordance with an AddRoundKey transformation conforming to the requirements of the Advanced Encryption Standard to produce a ciphertext indicative of the plaintext, wherein the step of populating the four result array rows of the result array using the plaintext conforms to the requirements of the Advanced Encryption Standard such that the ciphertext can be reverted to the plaintext using a decipher core conforming to the requirements of the Advanced Encryption Standard.

9. The non-transitory computer readable medium of illustrative embodiment 8, wherein the first lookup table has 256 first values, each of the 256 first values having one byte, and the second lookup table has 256 second values, each of the 256 second values having one byte.

10. The non-transitory computer readable medium of any one of illustrative embodiments 8-9, wherein the plaintext has 16 bytes arranged into four plaintext rows, including a first plaintext row, a second plaintext row, a third plaintext row, and a fourth plaintext row, each of the plaintext rows having four bytes, and the round key has 16 bytes.

11. The non-transitory computer readable medium of illustrative embodiment 10, wherein the step of shifting the bytes of the plaintext in accordance with the ShiftRows transformation is further defined as shifting the bytes of the plaintext such that the first plaintext row is shifted by zero bytes, the second plaintext row is shifted by one byte, the third plaintext row is shifted by two bytes, and the fourth plaintext row is shifted by three bytes.

12. A method, comprising:
storing a plaintext and a round key in a non-transitory computer readable medium, the plaintext being a data message to be encrypted having a plurality of bytes, the round key being an encryption key having a plurality of bytes;
shifting the bytes of the plaintext in accordance with a ShiftRows transformation conforming to requirements of an Advanced Encryption Standard;
populating four result array rows of a result array using the plaintext, wherein populating a result array row of the four result array rows includes:
   converting a first portion of the plaintext into a first result using a first lookup table, the first lookup table constructed by performing a byte substitution in accordance with a SubBytes transformation conforming to the requirements of an Advanced Encryption Standard, followed by a multiplication in GF(2⁸) by three modulo x⁴+1;
   converting a second portion of the plaintext into a second result using a second lookup table, the second lookup table constructed by performing a byte substitution in accordance with the SubBytes transformation, followed by a multiplication in GF(2⁸) by two modulo x⁴+1; and
   performing a bitwise even parity check, using as operands the first result, the second result, and a third portion of the plaintext to produce the result array row; and
adding the round key to the result array in accordance with an AddRoundKey transformation conforming to the requirements of the Advanced Encryption Standard to produce a ciphertext indicative of the plaintext, wherein the step of producing the four result array rows using the plaintext conforms to the requirements of the Advanced Encryption Standard such that the ciphertext can be reverted to the plaintext using a decipher core conforming to the requirements of the Advanced Encryption Standard.

13. The method of illustrative embodiment 12, wherein the first lookup table has 256 first values, each of the 256 first values having one byte, and the second lookup table has 256 second values, each of the 256 second values having one byte.

14. The method of any one of illustrative embodiments 12-13, wherein the plaintext has 16 bytes arranged into four plaintext rows, including a first plaintext row, a second plaintext row, a third plaintext row, and a fourth plaintext row, each of the plaintext rows having four bytes, and the round key has 16 bytes.

15. The method of illustrative embodiment 14, wherein the step of shifting the bytes of the plaintext in accordance with the ShiftRows transformation is further defined as shifting the bytes of the plaintext such that the first plaintext row is shifted by zero bytes, the second plaintext row is shifted by one byte, the third plaintext row is shifted by two bytes, and the fourth plaintext row is shifted by three bytes.

16. The method of illustrative embodiment 12, wherein the round key is a first round key of a plurality of round keys, each of the plurality of round keys together constituting a key schedule.

17. The method of illustrative embodiment 16, wherein the steps of the method are repeated using a new round key of the plurality of round keys until each of the plurality of round keys of the key schedule has been used.

From the above description, it is clear that the inventive concepts disclosed and claimed herein are well-adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

Even though particular combinations of features and steps are recited in the claims and/or disclosed in the specification, these combinations are not intended to limit the disclosure. In fact, many of these features and steps may be combined in ways not specifically recited in the claims and/or disclosed in the specification. Although each dependent claim listed below may directly depend on only one other claim, the disclosure includes each dependent claim in combination with every other claim in the claim set.

What is claimed is:

1. An encipher core, comprising:
a non-transitory computer-readable medium storing a first lookup table, a second lookup table, a plaintext, and a round key, the first lookup table constructed by performing a byte substitution in accordance with a SubBytes transformation conforming to requirements of an Advanced Encryption Standard followed by a multiplication in GF(2⁸) by three modulo x⁴+1, the second lookup table constructed by performing the byte substitution in accordance with the SubBytes transformation conforming to the requirements of the Advanced Encryption Standard followed by a multiplication in GF(2⁸) by two modulo x⁴+1, the plaintext being a data message to be encrypted having a plurality of bytes, the round key being a cipher key having a plurality of bytes;
a ShiftRows subassembly operable to shift the bytes of the plaintext in accordance with a ShiftRows transformation conforming to the requirements of the Advanced Encryption Standard;
a combined SubBytes and MixColumns subassembly including four combined SubBytes and MixColumns modules, each of the combined SubBytes and MixColumns modules including:
a first data conversion engine operable to convert a first portion of the plaintext into a first result using the first lookup table;
a second data conversion engine operable to convert a second portion of the plaintext into a second result using the second lookup table; and
a bitwise even parity checker operable to accept as operands the first result, the second result, and a third portion of the plaintext to produce a result array row; and
an AddRoundKey subassembly operable to add the round key to the result array in accordance with an AddRoundKey transformation conforming to the requirements of the Advanced Encryption Standard to produce a ciphertext indicative of the plaintext, the result array formed by the result array rows from the four combined SubBytes and MixColumns modules, wherein the combined SubBytes and MixColumns subassembly conforms to the requirements of the Advanced Encryption Standard such that the ciphertext can be reverted to the plaintext using a decipher core conforming to the requirements of the Advanced Encryption Standard.

2. The encipher core of claim 1, wherein the first lookup table has 256 first values, each of the 256 first values having one byte, and the second lookup table has 256 second values, each of the 256 second values having one byte.

3. The encipher core of claim 1, further comprising a finite state machine having a plurality of predetermined states including:
a ShiftRows state, wherein the ShiftRows subassembly is operated to shift the bytes of the plaintext in accordance with the ShiftRows transformation;
a combined SubBytes and MixColumns state, wherein the combined SubBytes and MixColumns subassembly is operated to produce the result array; and
an AddRoundKey state, wherein the AddRoundKey subassembly is operated to add the round key to the result array in accordance with the AddRoundKey transformation to produce the ciphertext, wherein the finite state machine is operable to transition between the plurality of predetermined states in response to detection of a trigger event.

4. The encipher core of claim 3, wherein the trigger event is indicative of the completion of a transformation by one of the ShiftRows subassembly, the combined SubBytes and MixColumns subassembly, and the AddRoundKey subassembly.

5. The encipher core of claim 1, wherein the plaintext has 16 bytes arranged into four plaintext rows including a first plaintext row, a second plaintext row, a third plaintext row, and a fourth plaintext row, each of the plaintext rows having four bytes, and the round key has 16 bytes.

6. The encipher core of claim 5, wherein the ShiftRows subassembly is operable to shift the bytes of the plaintext such that the first plaintext row is shifted by zero bytes, the second plaintext row is shifted by one byte, the third plaintext row is shifted by two bytes, and the fourth plaintext row is shifted by three bytes.

7. The encipher core of claim 5, wherein the combined SubBytes and MixColumns modules includes a first combined SubBytes and MixColumns module, a second combined SubBytes and MixColumns module, a third combined SubBytes and MixColumns module, and a fourth combined SubBytes and MixColumns module, wherein:
the first portion of the plaintext operated on by the first combined SubBytes and MixColumns module is the fourth plaintext row;
the second portion of the plaintext operated on by the first combined SubBytes and MixColumns module is the third plaintext row;
the third portion of the plaintext operated on by the first combined SubBytes and MixColumns module includes the first plaintext row and the second plaintext row;
the first portion of the plaintext operated on by the second combined SubBytes and MixColumns module is the third plaintext row;
the second portion of the plaintext operated on by the second combined SubBytes and MixColumns module is the second plaintext row;
the third portion of the plaintext operated on by the second combined SubBytes and MixColumns module includes the first plaintext row and the fourth plaintext row;
the first portion of the plaintext operated on by the third combined SubBytes and MixColumns module is the second plaintext row;
the second portion of the plaintext operated on by the third combined SubBytes and MixColumns module is the first plaintext row;
the third portion of the plaintext operated on by the third combined SubBytes and MixColumns module includes the third plaintext row and the fourth plaintext row;
the first portion of the plaintext operated on by the fourth combined SubBytes and MixColumns module is the first plaintext row;
the second portion of the plaintext operated on by the fourth combined SubBytes and MixColumns module is the fourth plaintext row; and
the third portion of the plaintext operated on by the first combined SubBytes and MixColumns module includes the third plaintext row and the second plaintext row.

8. A non-transitory computer readable medium having software instructions stored thereon that, when executed by a processor, cause the processor to:
receive a plaintext and a round key, the plaintext being a data message to be encrypted having a plurality of bytes, the round key being an encryption key having a plurality of bytes;
shift the bytes of the plaintext in accordance with a ShiftRows transformation conforming to requirements of an Advanced Encryption Standard;
populate four result array rows of a result array, wherein populating a result array row of the four result array rows includes:
converting a first portion of the plaintext into a first result using a first lookup table, the first lookup table constructed by performing a byte substitution in accordance with a SubBytes transformation conforming to the requirements of an Advanced Encryption Standard, followed by a multiplication in GF(2⁸) by three modulo x⁴+1;
converting a second portion of the plaintext into a second result using a second lookup table, the second lookup table constructed by performing a byte substitution in accordance with the SubBytes transformation, followed by a multiplication in GF(2⁸) by two modulo x⁴+1; and
performing a bitwise even parity check, using as operands the first result, the second result, and a third portion of the plaintext to produce the result array row; and
add the round key to the result array in accordance with an AddRoundKey transformation conforming to the requirements of the Advanced Encryption Standard to produce a ciphertext indicative of the plaintext, wherein the step of populating the four result array rows of the result array using the plaintext conforms to the requirements of the Advanced Encryption Standard such that the ciphertext can be reverted to the plaintext using a decipher core conforming to the requirements of the Advanced Encryption Standard.

9. The non-transitory computer readable medium of claim 8, wherein the first lookup table has 256 first values, each of the 256 first values having one byte, and the second lookup table has 256 second values, each of the 256 second values having one byte.

10. The non-transitory computer readable medium of claim 8, wherein the plaintext has 16 bytes arranged into four plaintext rows, including a first plaintext row, a second plaintext row, a third plaintext row, and a fourth plaintext row, each of the plaintext rows having four bytes, and the round key has 16 bytes.

11. The non-transitory computer readable medium of claim 10, wherein the step of shifting the bytes of the plaintext in accordance with the ShiftRows transformation is further defined as shifting the bytes of the plaintext such that the first plaintext row is shifted by zero bytes, the second plaintext row is shifted by one byte, the third plaintext row is shifted by two bytes, and the fourth plaintext row is shifted by three bytes.

12. A method, comprising:
storing a plaintext and a round key in a non-transitory computer readable medium, the plaintext being a data message to be encrypted having a plurality of bytes, the round key being an encryption key having a plurality of bytes;
shifting the bytes of the plaintext in accordance with a ShiftRows transformation conforming to requirements of an Advanced Encryption Standard;
populating four result array rows of a result array using the plaintext, wherein populating a result array row of the four result array rows includes:
converting a first portion of the plaintext into a first result using a first lookup table, the first lookup table constructed by performing a byte substitution in accordance with a SubBytes transformation conforming to the requirements of an Advanced Encryption Standard, followed by a multiplication in GF(2⁸) by three modulo x⁴+1;
converting a second portion of the plaintext into a second result using a second lookup table, the second lookup table constructed by performing a byte substitution in accordance with the SubBytes transformation, followed by a multiplication in GF(2⁸) by two modulo x⁴+1; and
performing a bitwise even parity check, using as operands the first result, the second result, and a third portion of the plaintext to produce the result array row; and
adding the round key to the result array in accordance with an AddRoundKey transformation conforming to the requirements of the Advanced Encryption Standard to produce a ciphertext indicative of the plaintext, wherein the step of producing the four result array rows using the plaintext conforms to the requirements of the Advanced Encryption Standard such that the ciphertext can be reverted to the plaintext using a decipher core conforming to the requirements of the Advanced Encryption Standard.

13. The method of claim 12, wherein the first lookup table has 256 first values, each of the 256 first values having one byte, and the second lookup table has 256 second values, each of the 256 second values having one byte.

14. The method of claim 12, wherein the plaintext has 16 bytes arranged into four plaintext rows, including a first plaintext row, a second plaintext row, a third plaintext row, and a fourth plaintext row, each of the plaintext rows having four bytes, and the round key has 16 bytes.

15. The method of claim 14, wherein the step of shifting the bytes of the plaintext in accordance with the ShiftRows transformation is further defined as shifting the bytes of the plaintext such that the first plaintext row is shifted by zero bytes, the second plaintext row is shifted by one byte, the third plaintext row is shifted by two bytes, and the fourth plaintext row is shifted by three bytes.

16. The method of claim 12, wherein the round key is a first round key of a plurality of round keys, each of the plurality of round keys together constituting a key schedule.

17. The method of claim 16, wherein the steps of the method are repeated using a new round key of the plurality of round keys until each of the plurality of round keys of the key schedule has been used.
